(19) United States
(12) Patent Application Publication
(10) Pub. No.: US 2004/0013179 A1
(43) Pub. Date: Jan. 22, 2004

(54) Apparatus for providing a multi-mode interface between a baseband transmitter and radio frequency circuitry

(76) Inventors: Tai-Yuan Cheng, Hsinchu (TW); Yi-Huei Chen, Hsinchu (TW); Jui-Hsi Cheng, Hsinchu (TW); Tsung-Liang Lin, Hsinchu (TW); Shu-Ping Hsu, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/298,439

(22) Filed: Nov. 18, 2002

Related U.S. Application Data
(60) Provisional application No. 60/397,050, filed on Jul. 19, 2002.

(51) Int. Cl. H04B 1/38

(52) U.S. Cl. 375/219

(57) ABSTRACT

An apparatus for providing a multi-mode interface between a baseband transmitter and radio frequency (RF) circuitry. According to a preferred embodiment of the invention, the apparatus includes a digital-to-analog converter, a single-ended-to-differential converter and a voltage-to-current converter. The digital-to-analog converter receives the digital signal from a baseband processor and converts the digital signal into a single-ended voltage signal. The single-ended-to-differential converter receives the single-ended voltage signal and converts it into a pair of differential voltage signals. Further, the voltage-to-current converter receives the pair of differential voltage signals and converts the voltage signal pair into a pair of differential current signals. Thus, the digital signal, the single-ended voltage signal, the differential voltage signal pair and the differential current signal pair together form the multi-mode interface to the RF circuitry.

### CROSS-REFERENCE TO RELATED APPLICATION

This application is a regular application and claims the benefit of priority from U.S. provisional patent application Ser. No. 60/397,050 filed Jul. 19, 2002, which is also related to a copending application entitled “Apparatus for Providing a Multi-mode Interface between a Baseband Receiver and Radio Frequency Circuitry”, U.S. patent application Ser. No. ______, filed ______.

### BACKGROUND OF THE INVENTION

1. Field of the Invention

The invention relates to wireless communications. More particularly, the invention relates to an apparatus for providing a multi-mode interface between a baseband integrated circuit and a radio frequency integrated circuit.

2. Description of the Related Art

Traditionally, a baseband integrated circuit (IC) may only be connected with a radio frequency (RF) IC through a fixed interface. As illustrated in FIG. 1A, RF circuitry 120 has an interface to transmit and receive single-ended voltage signals to and from baseband circuitry 110. The baseband circuitry 110 provides a corresponding interface to transmit a single-ended voltage signal 130 to the RF circuitry 120, and to receive a single-ended voltage signal 131 from the RF circuitry 120. Referring to FIG. 1B, RF circuitry 122 has an interface to transmit and receive differential voltage signals to and from baseband circuitry 112. To work with the RF circuitry 122, the baseband circuitry 112 provides a corresponding interface to transfer differential voltage signal pairs 132 and 133 with the RF circuitry 122. Turning now to FIG. 1C, baseband circuitry 114 provides an interface to transmit a pair of differential current signals 134 to RF circuitry 124, and to receive a pair of differential current signals 135 from the RF circuitry 124. Hence, the RF circuitry 124 must have a corresponding interface to receive and transmit differential current signals.

However, a conventional baseband IC with a fixed interface, which, as described above, will lack freedom in the choice of desired RF ICs. The conventional baseband IC also suffers from difficulty in replacing an existing RF IC with other types. Therefore, what is needed is a baseband IC, especially, a baseband transmitter incorporating a multi-mode interface to flexibly connect a wide variety of types of RF circuitry, unencumbered by the limitations associated with the prior art.

### SUMMARY OF THE INVENTION

It is an object of the present invention to provide an apparatus for providing a multi-mode interface between a baseband transmitter and radio frequency (RF) circuitry.

The present invention is generally directed to a baseband transmitter incorporating a baseband processor that generates a digital signal to be transmitted through RF circuitry. According to one aspect of the invention, the apparatus includes a digital-to-analog converter and a single-ended-to-differential converter. The digital-to-analog converter is adapted to receive the digital signal from the baseband processor and output an outgoing single-ended signal. The single-ended-to-differential converter takes the outgoing single-ended signal and outputs an outgoing pair of differential signals. Consequently, the digital signal, the outgoing single-ended signal and the outgoing differential signal pair together form the multi-mode interface, in which these signals are selectively allowed to output to the RF circuitry.

According to another aspect of the invention, the apparatus includes a digital-to-analog converter and a differential-to-single-ended converter. The digital-to-analog converter is adapted to receive the digital signal from the baseband processor and output an outgoing pair of differential signals. The differential-to-single-ended converter takes the outgoing differential signal pair and outputs an outgoing single-ended signal. Thus, the outgoing single-ended signal and the outgoing differential signal pair are provided to form the multi-mode interface to the RF circuitry.

In one embodiment of the present invention, the apparatus includes a digital-to-analog converter, a single-ended-to-differential converter and a voltage-to-current converter. The digital-to-analog converter is adapted to receive the digital signal from the baseband processor, and it is configured to convert the digital signal into a single-ended voltage signal. The single-ended-to-differential converter is coupled to the digital-to-analog converter to receive the single-ended voltage signal. The single-ended-to-differential converter is configured to convert the single-ended voltage signal into a pair of differential voltage signals. The voltage-to-current converter is coupled to the single-ended-to-differential converter to receive the differential voltage signal pair. It further converts the differential voltage signal pair into a pair of differential current signals. In addition, multiple output terminals are provided. A first output terminal is coupled to the digital-to-analog converter such that it receives and outputs the single-ended voltage signal. Second and third output terminals are coupled to the single-ended-to-differential converter, respectively. These two terminals are together used to receive and output the differential voltage signal pair. Fourth and fifth output terminals are coupled to the voltage-to-current converter, respectively. The fourth and the fifth output terminals are used to receive and output the differential voltage signal pair.

### BRIEF DESCRIPTION OF THE DRAWINGS

The present invention will be described by way of exemplary embodiments, but not limitations, illustrated in the accompanying drawings in which like references denote similar elements, and in which:

FIGS. 1A˜1C are block diagrams illustrating RF ICs with commonly used interfaces to connect corresponding types of baseband ICs in accordance with the prior art;

FIG. 2 is a block diagram illustrating a baseband transmitter with an interface conversion module of the invention;

FIGS. 3A˜3P are basic building blocks for the interface conversion module in accordance with the invention;

FIGS. 4A˜4D are block diagrams illustrating four structures that can be used to implement the interface conversion module in accordance with the invention;

FIG. 5 is a block diagram illustrating a first embodiment of the invention;

FIG. 6 is a block diagram illustrating a second embodiment of the invention; and

FIG. 7 is a block diagram illustrating a third embodiment of the invention.

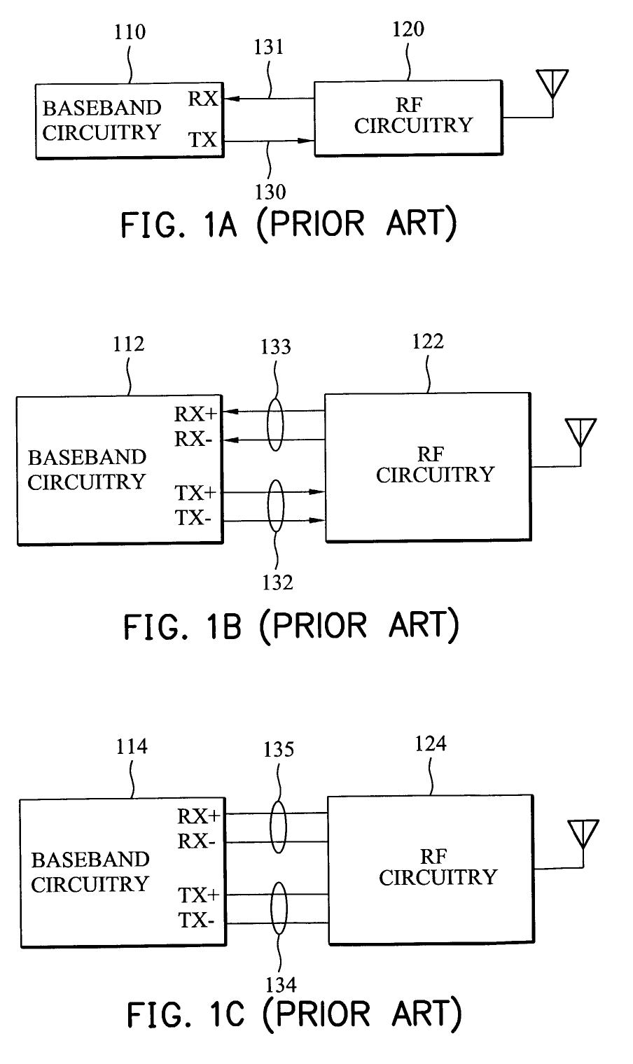

### DETAILED DESCRIPTION OF THE INVENTION

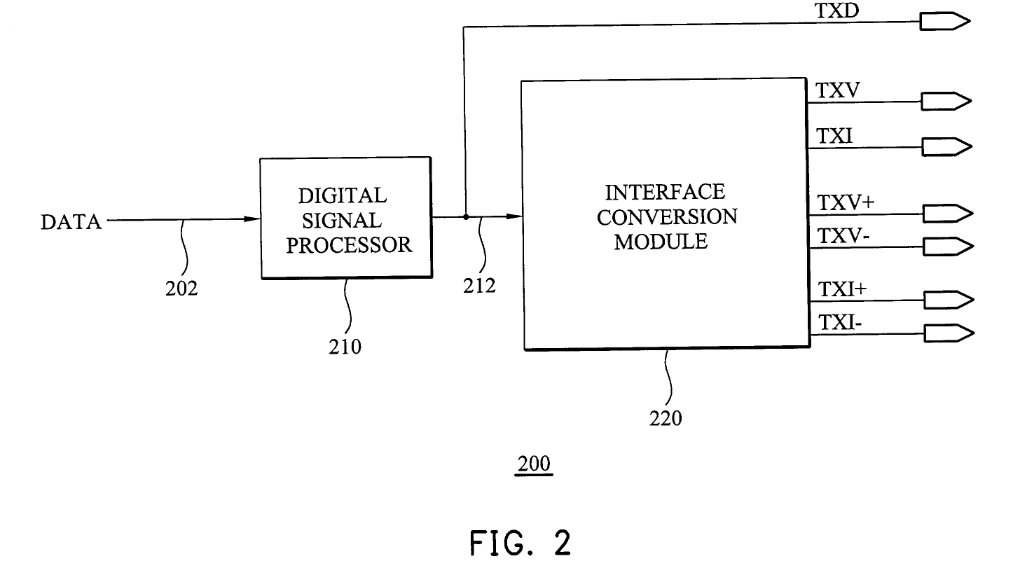

FIG. 2 illustrates a block diagram of a baseband transmitter 200 according to the invention. As depicted, digital signal processor (DSP) 210 receives data via line 202 and outputs digital signals over line 212. The DSP 210 serves as a baseband processor to process the data to be transmitted before forwarding it to RF circuitry (not shown). To establish a multi-mode interface between a baseband IC and a RF IC, an interface conversion module 220 converts the digital signals into various signal modes. The interface conversion module 220 is able to provide a single-ended voltage signal and a single-ended current signal on the TXV and TXI outputs, respectively. The interface conversion module 220 can also provide a pair of differential voltage signals on the TXV+ and TXV− outputs, and provide a pair of differential current signals on the TXI+ and TXI− outputs. On some occasions, RF circuitry may directly translate a digital signal to an analog signal at radio frequency. Therefore, the TXD output of the baseband transmitter 200 is available to bypass the interface conversion module 220 in order to plainly output such a digital signal. It should be appreciated that the interface conversion module 220 is well suited for both in-phase (I) and quadrature (Q) components of baseband signals.

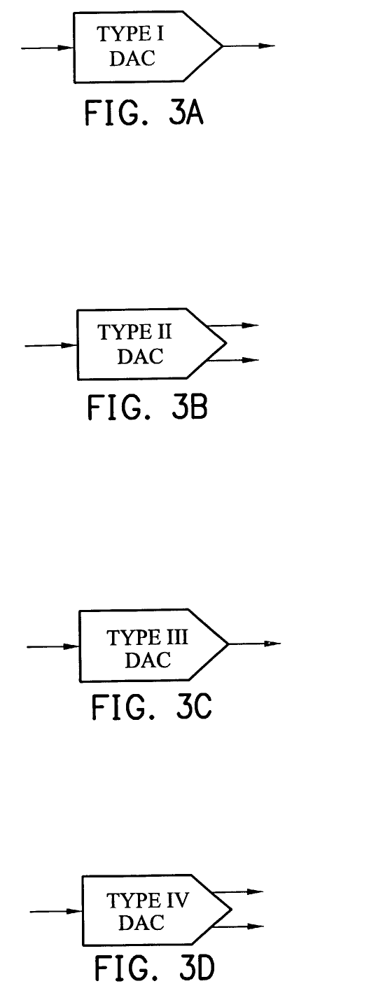

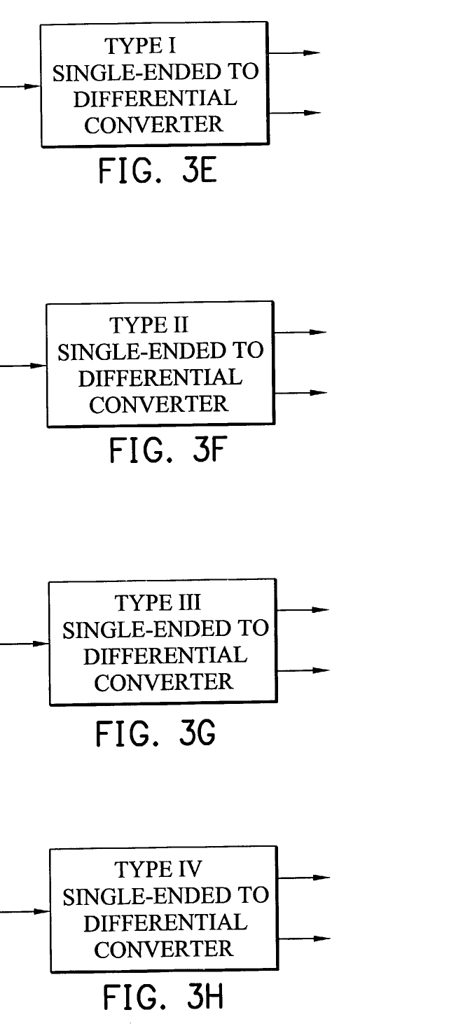

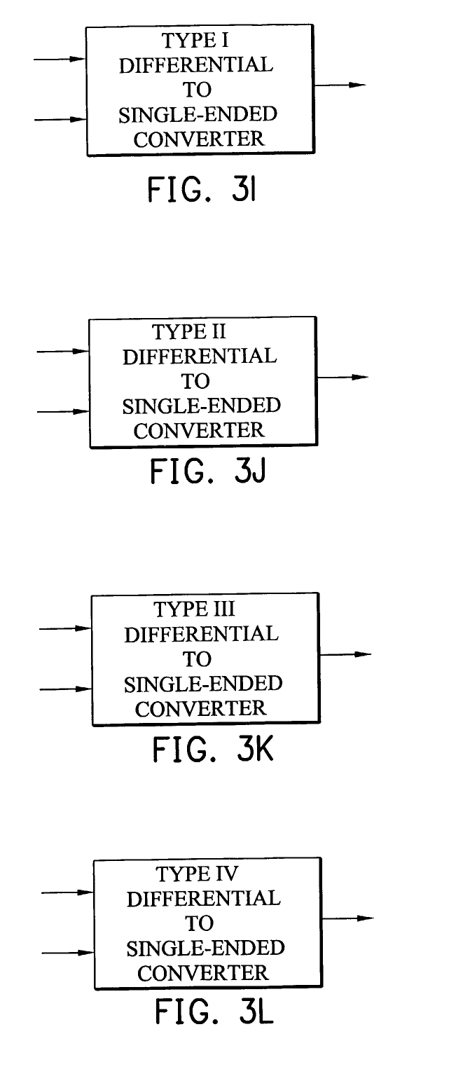

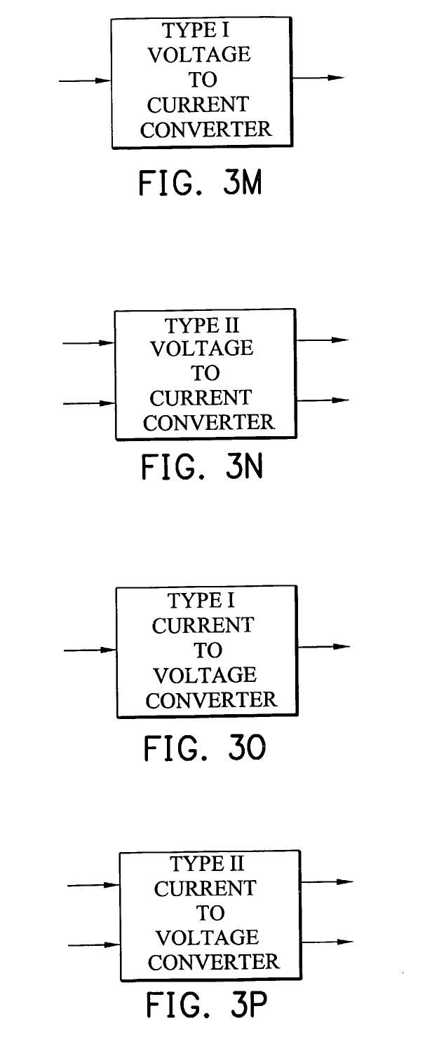

According to the invention, the interface conversion module 220 can be implemented with the following basic building blocks. For brevity, these basic components illustrated in FIGS. 3A˜3P are divided into five categories. The first category encompasses four types of digital-to-analog converters (DACs). TYPE 1 shown in FIG. 3A is a single-ended voltage output DAC. TYPE 2 shown in FIG. 3B is a differential voltage output DAC. TYPE 3 shown in FIG. 3C is a single-ended current output DAC. TYPE 4 shown in FIG. 3D is a differential current output DAC. The second category refers to single-ended-to-differential converters (SDCs) which convert a single-ended signal into a pair of differential signals. TYPE 1 shown in FIG. 3E is a single-ended voltage input and differential voltage output SDC. TYPE 2 shown in FIG. 3F is a single-ended current input and differential voltage output SDC. TYPE 3 shown in FIG. 3G is a single-ended voltage input and differential current output SDC. TYPE 4 shown in FIG. 3H is a single-ended current input and differential current output SDC. The third category pertains to differential-to-single-ended converters (DSCs) which convert a pair of differential signals into a single-ended signal. TYPE 1 shown in FIG. 3I is a differential voltage input and single-ended voltage output DSC. TYPE 2 shown in FIG. 3J is a differential current input and single-ended voltage output DSC. TYPE 3 shown in FIG. 3K is a differential voltage input and single-ended current output DSC. TYPE 4 shown in FIG. 3L is a differential current input and single-ended current output DSC. The fourth category includes two types of voltage-to-current converters (VCCs) which convert a voltage signal into a current signal. TYPE 1 shown in FIG. 3M is a single-ended input and single-ended output VCC. TYPE 2 shown in FIG. 3N is a differential input and differential output VCC. The fifth category contains two types of current-to-voltage converters (CVCs) which convert a current signal into a voltage signal. As illustrated in FIGS. 30 and 3P, TYPE 1 is a single-ended input and single-ended output CVC, and TYPE 2 is a differential input and differential output CVC, respectively.

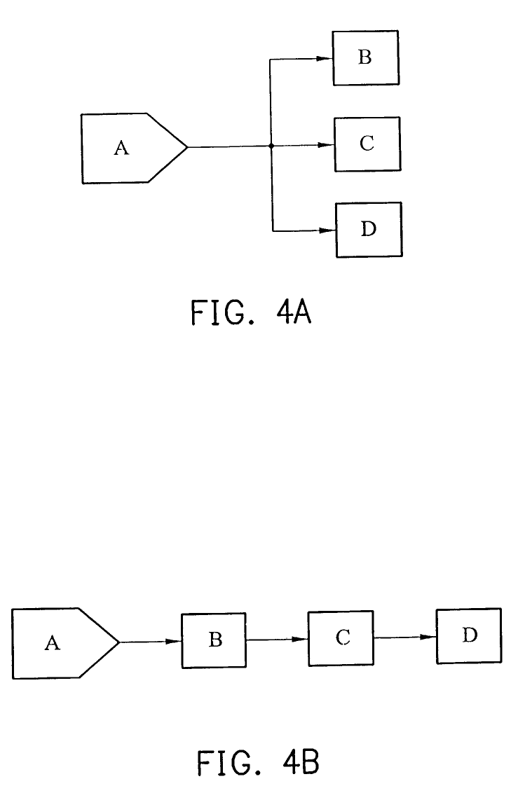

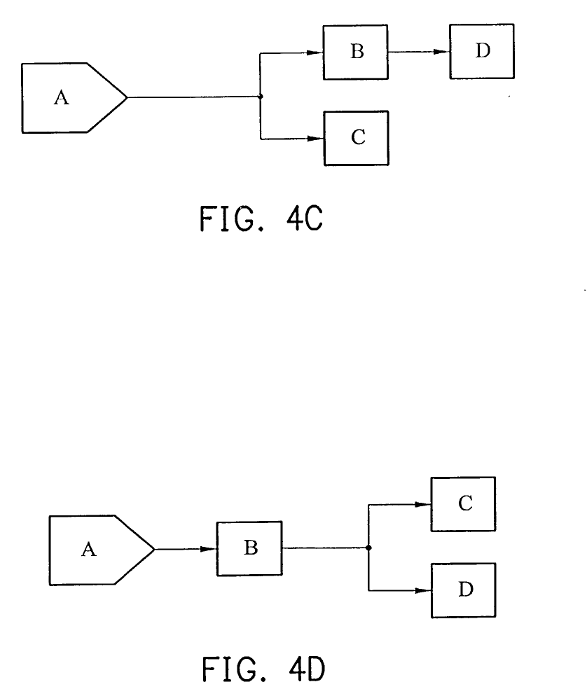

Using these basic components, the interface conversion module 220 can be implemented with four structures. Referring to FIG. 4A, the first structure is a parallel form. In this form the selected basic components are connected in parallel, and the possible configurations for the parallel form are listed here in TABLE 1. Referring to FIG. 4B, the second structure is a cascade form. In this form the selected basic components are connected in cascade, and the possible configurations for the cascade form are listed here in TABLE 2. Referring to FIG. 4C, the third structure is a hybrid form I. In this form, as depicted, the selected basic components are connected in a combination of parallel and cascade forms, and the possible configurations for the hybrid form I are listed here in TABLE 3. Turning now to FIG. 4D, the fourth structure is a hybrid form II. In this form, as depicted, the selected basic components are connected in a second combination of parallel and cascade forms, and the possible configurations for the hybrid form II are listed here in TABLE 4. With respect to FIGS. 4A˜4C as well as TABLES 1˜4, note that block A is representative of the DACs, and Blocks B, C and D are selected from the other categories of the basic building blocks. It should be understood that any suitable permutations and combinations of the basic components are contemplated to implement the interface conversion module 220 by the principles of the invention.

TABLE 1

| | A | B | C | D |
|---|---|---|---|---|
| 1 | TYPE 1 DAC | TYPE 1 VCC | TYPE 1 SDC | TYPE 3 SDC |
| 2 | TYPE 2 DAC | TYPE 2 VCC | TYPE 1 DSC | TYPE 3 DSC |
| 3 | TYPE 3 DAC | TYPE 1 CVC | TYPE 2 SDC | TYPE 4 SDC |
| 4 | TYPE 4 DAC | TYPE 2 CVC | TYPE 2 DSC | TYPE 4 DSC |

TABLE 2

| | A | B | C | D |
|---|---|---|---|---|
| 1 | TYPE 1 DAC | TYPE 1 VCC | TYPE 2 SDC | TYPE 2 VCC |
| 2 | TYPE 1 DAC | TYPE 1 SDC | TYPE 2 VCC | TYPE 4 DSC |
| 3 | TYPE 1 DAC | TYPE 3 SDC | TYPE 2 CVC | TYPE 3 DSC |
| 4 | TYPE 1 DAC | TYPE 1 VCC | TYPE 4 SDC | TYPE 2 CVC |
| 5 | TYPE 1 DAC | TYPE 1 SDC | TYPE 3 DSC | TYPE 4 SDC |
| 6 | TYPE 1 DAC | TYPE 3 SDC | TYPE 4 DSC | TYPE 2 SDC |
| 7 | TYPE 2 DAC | TYPE 2 VCC | TYPE 2 DSC | TYPE I VCC |
| 8 | TYPE 2 DAC | TYPE 1 DSC | TYPE 3 SDC | TYPE 4 DSC |
| 9 | TYPE 2 DAC | TYPE 3 DSC | TYPE 4 SDC | TYPE 2 DSC |
| 10 | TYPE 2 DAC | TYPE 2 VCC | TYPE 4 DSC | TYPE 1 CVC |
| 11 | TYPE 2 DAC | TYPE 3 DSC | TYPE 1 CVC | TYPE 4 SDC |
| 12 | TYPE 2 DAC | TYPE 1 DSC | TYPE 1 VCC | TYPE 4 SDC |
| 13 | TYPE 3 DAC | TYPE 1 CVC | TYPE 1 SDC | TYPE 2 VCC |
| 14 | TYPE 3 DAC | TYPE 2 SDC | TYPE 1 DSC | TYPE 3 SDC |
| 15 | TYPE 3 DAC | TYPE 4 SDC | TYPE 2 DSC | TYPE 1 SDC |
| 16 | TYPE 3 DAC | TYPE 1 CVC | TYPE 3 SDC | TYPE 2 CVC |
| 17 | TYPE 3 DAC | TYPE 2 SDC | TYPE 2 VCC | TYPE 2 DSC |
| 18 | TYPE 3 DAC | TYPE 4 SDC | TYPE 2 CVC | TYPE 1 DSC |
| 19 | TYPE 4 DAC | TYPE 2 DSC | TYPE 1 VCC | TYPE 2 SDC |
| 20 | TYPE 4 DAC | TYPE 4 DSC | TYPE 1 CVC | TYPE 1 SDC |
| 21 | TYPE 4 DAC | TYPE 2 CVC | TYPE 1 DSC | TYPE 1 VCC |
| 22 | TYPE 4 DAC | TYPE 2 DSC | TYPE 1 SDC | TYPE 3 DSC |
| 23 | TYPE 4 DAC | TYPE 4 DSC | TYPE 2 SDC | TYPE 1 DSC |
| 24 | TYPE 4 DAC | TYPE 2 CVC | TYPE 3 DSC | TYPE 1 CVC |

TABLE 3

| | A | B | C | D |
|---|---|---|---|---|
| 1 | TYPE 1 DAC | TYPE 1 VCC | TYPE 1 SDC | TYPE 4 SDC |
| 2 | TYPE 1 DAC | TYPE 1 SDC | TYPE 1 VCC | TYPE 2 VCC |
| 3 | TYPE 1 DAC | TYPE 1 VCC | TYPE 3 SDC | TYPE 4 SDC |
| 4 | TYPE 1 DAC | TYPE 3 SDC | TYPE 1 VCC | TYPE 2 CVC |
| 5 | TYPE 1 DAC | TYPE 1 SDC | TYPE 3 SDC | TYPE 3 DSC |
| 6 | TYPE 1 DAC | TYPE 3 SDC | TYPE 1 SDC | TYPE 4 DSC |
| 7 | TYPE 2 DAC | TYPE 3 DSC | TYPE 1 DSC | TYPE 4 SDC |
| 8 | TYPE 2 DAC | TYPE 1 DEC | TYPE 3 DSC | TYPE 3 SDC |
| 9 | TYPE 2 DAC | TYPE 3 DEC | TYPE 2 VCC | TYPE 1 CVC |
| 10 | TYPE 2 DAC | TYPE 2 VCC | TYPE 3 DSC | TYPE 2 DSC |
| 11 | TYPE 2 DAC | TYPE 2 VCC | TYPE 1 DSC | TYPE 4 DSC |
| 12 | TYPE 2 DAC | TYPE 1 DSC | TYPE 2 VCC | TYPE 1 VCC |
| 13 | TYPE 3 DAC | TYPE 2 SDC | TYPE 4 SDC | TYPE 1 DSC |
| 14 | TYPE 3 DAC | TYPE 4 SDC | TYPE 2 SDC | TYPE 2 DSC |
| 15 | TYPE 3 DAC | TYPE 2 SDC | TYPE 1 CVC | TYPE 2 VCC |
| 16 | TYPE 3 DAC | TYPE 1 CVC | TYPE 2 SDC | TYPE 3 SDC |
| 17 | TYPE 3 DAC | TYPE 4 SDC | TYPE 1 CVC | TYPE 2 CVC |
| 18 | TYPE 3 DAC | TYPE 1 CVC | TYPE 4 SDC | TYPE 1 SDC |
| 19 | TYPE 4 DAC | TYPE 4 DSC | TYPE 2 DSC | TYPE 2 SDC |
| 20 | TYPE 4 DAC | TYPE 2 DSC | TYPE 4 DSC | TYPE 1 SDC |
| 21 | TYPE 4 DAC | TYPE 4 DSC | TYPE 2 CVC | TYPE 1 CVC |
| 22 | TYPE 4 DAC | TYPE 2 CVC | TYPE 4 DSC | TYPE 1 DSC |
| 23 | TYPE 4 DAC | TYPE 2 DSC | TYPE 2 CVC | TYPE 1 VCC |
| 24 | TYPE 4 DAC | TYPE 2 CVC | TYPE 2 DSC | TYPE 3 DSC |

TABLE 4

| | A | B | C | D |
|---|---|---|---|---|
| 1 | TYPE 1 DAC | TYPE 1 VCC | TYPE 2 SDC | TYPE 4 SDC |
| 2 | TYPE 1 DAC | TYPE 1 SDC | TYPE 2 VCC | TYPE 3 DSC |
| 3 | TYPE 1 DAC | TYPE 3 SDC | TYPE 2 CVC | TYPE 4 DSC |
| 4 | TYPE 2 DAC | TYPE 2 VCC | TYPE 2 DSC | TYPE 4 DSC |
| 5 | TYPE 2 DAC | TYPE 1 DSC | TYPE 3 SDC | TYPE 1 VCC |
| 6 | TYPE 2 DAC | TYPE 3 DSC | TYPE 4 SDC | TYPE 1 CVC |
| 7 | TYPE 3 DAC | TYPE 1 CVC | TYPE 1 SDC | TYPE 3 SDC |
| 8 | TYPE 3 DAC | TYPE 2 SDC | TYPE 1 DSC | TYPE 2 VCC |
| 9 | TYPE 3 DAC | TYPE 4 SDC | TYPE 2 DSC | TYPE 2 CVC |
| 10 | TYPE 4 DAC | TYPE 2 DSC | TYPE 1 VCC | TYPE 1 SDC |
| 11 | TYPE 4 DAC | TYPE 4 DSC | TYPE 1 CVC | TYPE 2 SDC |
| 12 | TYPE 4 DAC | TYPE 2 CVC | TYPE 1 DSC | TYPE 3 DSC |

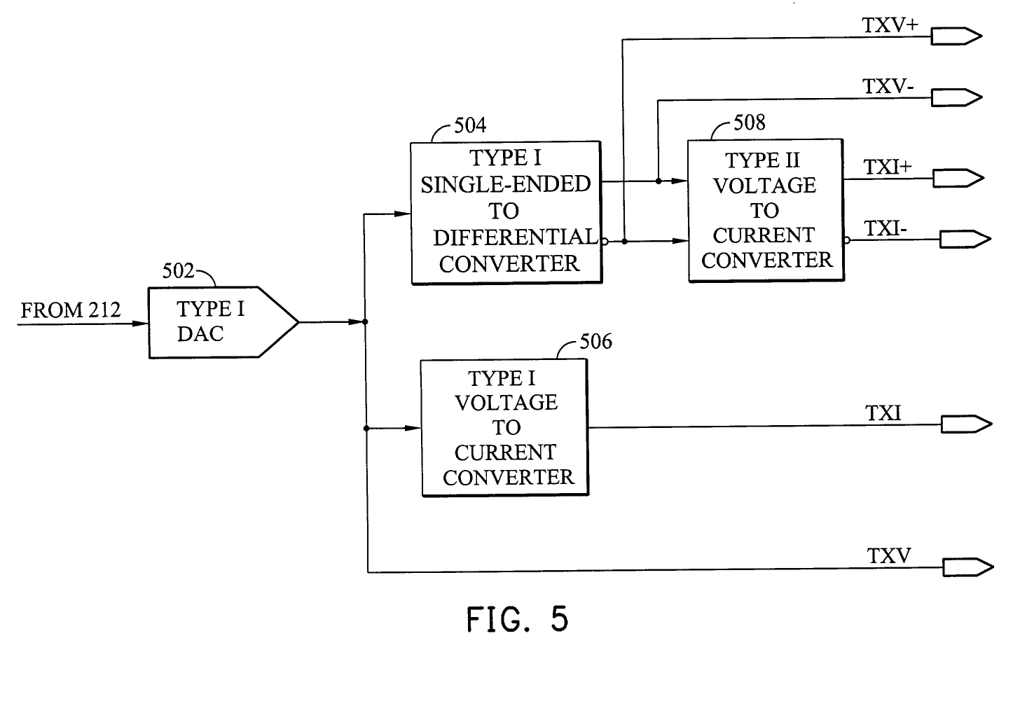

As an example of the implementation of the interface conversion module 220 in terms of the basic components, one embodiment of the invention is illustrated in FIG. 5. In this embodiment, the interface conversion module 220 is implemented with the hybrid form I of the invention. From configuration 2 listed in TABLE 3, block A is the TYPE 1 DAC, block B is the TYPE 1 SDC, block C is the TYPE 1 VCC, and block D is the TYPE 2 VCC. The TYPE 1 DAC 502 receives the digital signal from the baseband processor via line 212, performs a conversion of the digital signal to a single-ended voltage signal, and provides the voltage signal on the TXV output. Next, the TYPE 1 SDC 504 is coupled to the TYPE 1 DAC 502 and receives the single-ended voltage signal. The TYPE 1 SDC 504 performs a conversion of the single-ended voltage signal to a pair of differential voltage signals and provides the differential voltage pair on the TXV+ and TXV− outputs. The TYPE 2 VCC 508 is connected to the TYPE 1 SDC 504 in series. The TYPE 2 VCC 508 receives the differential voltage signal pair from the TYPE 1 SDC 504, converts the differential voltage signal pair to a pair of differential current signals, and provides the differential current pair on the TXI+ and TXI− outputs. Optionally, the TYPE 1 VCC 506 is provided to receive the single-ended voltage signal from the TYPE 1 DAC 502. The TYPE 1 VCC 506 performs a conversion of the single-ended voltage signal to a single-ended current signal and provides it on the TXI output. Thus, the interface conversion module 220 offers a multi-mode interface between the baseband transmitter 200 and a RF IC.

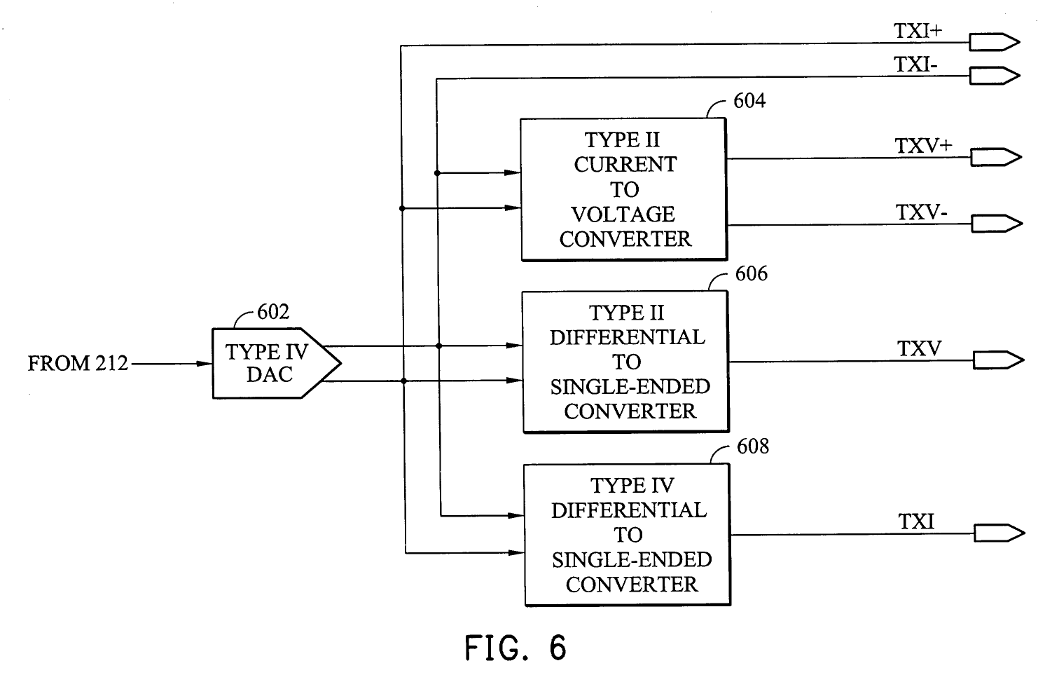

In a second embodiment, the interface conversion module 220 is implemented with the parallel form as shown in FIG. 6. From configuration 4 listed in TABLE 1, block A is the TYPE 4 DAC, block B is the TYPE 2 CVC, block C is the TYPE 2 DSC, and block D is the TYPE 4 DSC. The TYPE 4 DAC 602 receives the digital signal from the baseband processor via line 212, performs a conversion of the digital signal to a pair of differential current signals, and provides the differential current pair on the TXI+ and TXI− outputs. The TYPE 4 DAC 602 is further coupled to a parallel connection of the TYPE 2 CVC 604, the TYPE 2 DSC 606 and the TYPE 4 DSC 608, as well as feeding the differential current signal pair thereto. The TYPE 2 CVC 604 is provided to convert the differential current signal pair into a pair of differential voltage signals and provides the differential voltage pair on the TXV+ and TXV− outputs. The TYPE 2 DSC 606 is provided to convert the differential current signal pair into a single-ended voltage signal and provides it on the TXV output. Additionally, the TYPE 4 DSC 608 performs a conversion of the differential current signal pair to a single-ended current signal and provides it on the TXI output.

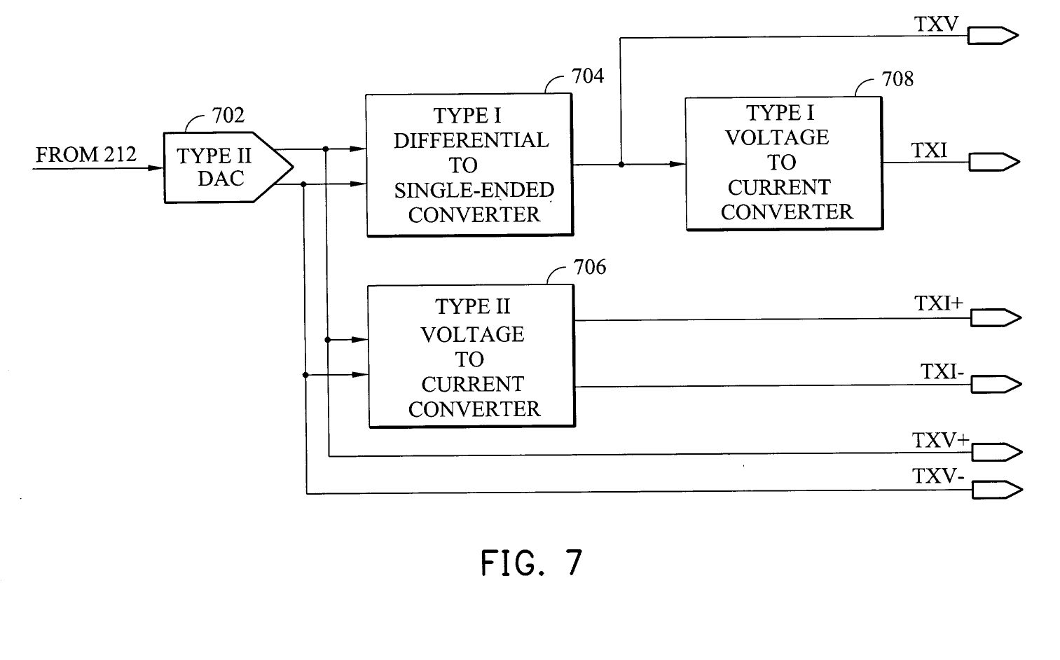

Turning now to FIG. 7, a third embodiment of the invention is implemented with the hybrid form I. From configuration 12 set forth in TABLE 3, block A is the TYPE 2 DAC, block B is the TYPE 1 DSC, block C is the TYPE 2 VCC, and block D is the TYPE 1 VCC. The TYPE 2 DAC 702 receives the digital signal from the baseband processor via line 212, performs a conversion of the digital signal to a pair of differential voltage signals, and provides the differential voltage pair on the TXV+ and TXV− outputs. Next, the TYPE 2 DAC 702 is coupled to the parallel connection of the TYPE 1 DSC 704 and the TYPE 2 VCC 706. The TYPE 1 DSC 704 and the TYPE 2 VCC 706 both receive the differential voltage signal pair from the TYPE 2 DAC 702. The TYPE 1 DSC 704 performs a conversion of the differential voltage signal pair to a single-ended voltage signal, and provides the single-ended voltage signal on the TXV output. On the other hand, the TYPE 2 VCC 706 performs a conversion of the differential voltage signal pair to a pair of differential current signals and provides the differential current pair on the TXI+ and TXI− outputs. In addition, the TYPE 1 VCC 708 is connected to the TYPE 1 DSC 704 in series. The TYPE 1 VCC 708 receives the single-ended voltage signal from the TYPE 1 DSC 704. It further converts the single-ended voltage signal to a single-ended current signal and provides the single-ended current signal on the TXI output.

With the highly flexible multi-mode interface, the baseband transmitter 200 offers all necessary output modes to accommodate the most common RF ICs in the industry. It should be appreciated that the baseband transmitter 200 needs not enable all of the output modes at the same time. The output modes of the baseband transmitter 200 may be digital, single-ended voltage, single-ended current, differential voltage or differential current, or a combination. When one of the output modes is chosen to interface with the desired RF IC, the rest of the output modes have to be disabled. The inoperative components implemented in the interface conversion module 220 may enter a power-down state to prevent unnecessary power consumption. Furthermore, depending on practical applications, baseband receivers working in conjunction with the baseband transmitter of the invention are not limited to those having symmetrical design and corresponding interface.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An apparatus for providing a multi-mode interface between a baseband transmitter and radio frequency (RF) circuitry, the baseband transmitter incorporating a baseband processor that generates a digital signal to be transmitted through the RF circuitry, the apparatus comprising:
a digital-to-analog converter adapted to receive the digital signal from the baseband processor and perform a conversion of the digital signal to a single-ended voltage signal;
a single-ended-to-differential converter coupled to the digital-to-analog converter to receive the single-ended voltage signal, for performing a conversion of the single-ended voltage signal to a pair of differential voltage signals;
a first voltage-to-current converter coupled to the single-ended-to-differential converter to receive the differential voltage signal pair, for performing a conversion of the differential voltage signal pair to a pair of differential current signals;
a first output terminal coupled to the digital-to-analog converter, for receiving and outputting the single-ended voltage signal;
a second and third output terminal coupled to the single-ended-to-differential converter, for receiving and outputting the differential voltage signal pair; and
a fourth and fifth output terminal coupled to the first voltage-to-current converter, for receiving and outputting the differential current signal pair.

2. The apparatus as recited in claim 1 further comprising:
a second voltage-to-current converter coupled to the digital-to-analog converter to receive the single-ended voltage signal, for performing a conversion of the single-ended voltage signal to a single-ended current signal; and
a sixth output terminal coupled to the second voltage-to-current converter, for receiving and outputting the single-ended current signal.

3. The apparatus as recited in claim 1 further comprising a seventh output terminal for receiving the digital signal from the baseband processor and outputting the digital signal directly.

4. An apparatus for providing a multi-mode interface between a baseband transmitter and radio frequency (RF) circuitry, the baseband transmitter incorporating a baseband processor that generates a digital signal to be transmitted through the RF circuitry, the apparatus comprising:
a digital-to-analog converter adapted to receive the digital signal from the baseband processor and output an outgoing single-ended signal; and
a first single-ended-to-differential converter for taking the outgoing single-ended signal and outputting an outgoing pair of differential signals;
whereby the digital signal, the outgoing single-ended signal and the outgoing differential signal pair together form the multi-mode interface to the RF circuitry.

5. The apparatus as recited in claim 4 wherein the digital-to-analog converter changes the digital signal into a single-ended voltage signal as the outgoing single-ended signal.

6. The apparatus as recited in claim 5 further comprising a voltage-to-current converter for receiving the single-ended voltage signal from the digital-to-analog converter, performing a conversion of the single-ended voltage signal to a single-ended current signal, and outputting the single-ended current signal.

7. The apparatus as recited in claim 5 wherein the first single-ended-to-differential converter changes the single-ended voltage signal from the digital-to-analog converter into a pair of differential voltage signals as the outgoing differential signal pair.

8. The apparatus as recited in claim 7 further comprising a second single-ended-to-differential converter for receiving the single-ended voltage signal from the digital-to-analog converter, performing a conversion of the single-ended voltage signal to a pair of differential current signals, and outputting the differential current signal pair.

9. The apparatus as recited in claim 7 further comprising a voltage-to-current converter for receiving the differential voltage signal pair, for performing a conversion of the differential voltage signal pair to a pair of differential current signals, and outputting the differential current signal pair.

10. The apparatus as recited in claim 4 further comprising an output terminal to provide the digital signal directly such that the multi-mode interface includes the outgoing single-ended signal, the outgoing differential signal pair and the digital signal.

11. An apparatus for providing a multi-mode interface between a baseband transmitter and radio frequency (RF) circuitry, the baseband transmitter incorporating a baseband processor that generates a digital signal to be transmitted through the RF circuitry, the apparatus comprising:
a digital-to-analog converter adapted to receive the digital signal from the baseband processor and output an outgoing pair of differential signals; and
a first differential-to-single-ended converter for taking the outgoing differential signal pair and outputting an outgoing single-ended signal;
whereby the digital signal, the outgoing single-ended signal and the outgoing differential signal pair form the multi-mode interface to the RF circuitry.

12. The apparatus as recited in claim 11 wherein the digital-to-analog converter changes the digital signal into a pair of differential current signals as the outgoing differential signal pair.

13. The apparatus as recited in claim 12 further comprising a current-to-voltage converter for receiving the differential current signal pair from the digital-to-analog converter, performing a conversion of the differential current signal pair to a pair of differential voltage signals, and outputting the differential voltage signal pair.

14. The apparatus as recited in claim 12 wherein the first differential-to-single-ended converter changes the differential current signal pair into a single-ended voltage signal as the outgoing single-ended signal.

15. The apparatus as recited in claim 12 further comprising a second differential-to-single-ended converter for receiving the differential current signal pair from the digital-to-analog converter, performing a conversion of the differential current signal pair to a single-ended current signal, and outputting the single-ended current signal.

16. The apparatus as recited in claim 11 wherein the digital-to-analog converter changes the digital signal into a pair of differential voltage signals as the outgoing differential signal pair.

17. The apparatus as recited in claim 16 further comprising a voltage-to-current converter for receiving the differential voltage signal pair from the digital-to-analog converter, performing a conversion of the differential voltage signal pair to a pair of differential current signals, and outputting the differential current signal pair.

18. The apparatus as recited in claim 16 wherein the first differential-to-single-ended converter changes the differential voltage signal pair into a single-ended voltage signal as the outgoing single-ended signal.

19. The apparatus as recited in claim 16 further comprising a second differential-to-single-ended converter for receiving the differential voltage signal pair from the digital-to-analog converter, performing a conversion of the differential voltage signal pair to a single-ended current signal, and outputting the single-ended current signal.

20. The apparatus as recited in claim 11 further comprising an output terminal to provide the digital signal directly such that the multi-mode interface includes the outgoing single-ended signal, the outgoing differential signal pair and the digital signal.
